(19) United States
(12) Patent Application Publication
(10) Pub. No.: US 2025/0200485 A1
(43) Pub. Date: Jun. 19, 2025

(54) SENTIMENTAL IMPACTS ASSOCIATED WITH PROCESS MINING

(71) Applicant: INTERNATIONAL BUSINESS MACHINES CORPORATION, ARMONK, NY (US)

(72) Inventors: AMANDA NICOLE WILK, New York, NY (US); Robert Huntington Grant, Marietta, GA (US); BRUNO HUPIN, Ipswich, MA (US); Zachary A. Silverstein, Georgetown, TX (US)

(21) Appl. No.: 18/544,588

(22) Filed: Dec. 19, 2023

(51) Int. Cl. G06Q 10/0639

(52) U.S. Cl. CPC G06Q 10/06393

(57) ABSTRACT

A method, computer system, and a computer program product for process mining and optimization is provided. The present invention may include identifying a process to be analyzed, wherein the process is comprised of one or more activities. The present invention my include generating a list of relevant individuals corresponding to the process and requesting access to collaborative communications between one or more individuals from the list of relevant individuals. The present invention may include generating one or more scores based on the collaborative communications between the one or more individuals. The present invention may include updating the process within the user interface using the one or more scores to enrich the process with additional contextual data.

### BACKGROUND

The present invention relates generally to the field of computing, and more particularly to extracting out collaborative sentiment based on a mined and automated process.

A process may be defined as a collection of related, structured activities or tasks performed by an entity that produce a result such as a product or service for a customer. Processes may also be utilized internally by an entity in accomplishing certain tasks. Process management may involve leveraging process mining techniques in order to adapt and/or continuously improve a process which may enable an entity to improve time to execute, delays, costs, amongst other improvements which may enable the entity to stay competitive. Process management may also include the entity identifying automation opportunities within a process by determining tasks and/or activities within the process which may be handled using a bot. However, the current state of process management fails to ensure that a process' sentimental impacts are captured in associated with process mining.

### SUMMARY

Embodiments of the present invention disclose a method, computer system, and a computer program product for process mining and optimization. The present invention may include identifying a process to be analyzed, wherein the process is comprised of one or more activities, and wherein the process is identified based on a selection made by a user within a user interface. The present invention my include generating a list of relevant individuals corresponding to the process and requesting access to collaborative communications between one or more individuals from the list of relevant individuals. The present invention may include generating one or more scores based on the collaborative communications between the one or more individuals, wherein the one or more scores correspond to the one or more activities comprising the process. The present invention may include updating the process within the user interface using the one or more scores to enrich the process with additional contextual data such that the user may visualize which of the one or more activities comprising the process provide further automation opportunities. Accordingly, the present invention may enable the capturing of satisfaction that both upstream and downstream individuals have as a factor and enable more efficient and targeted process management.

In another embodiment, the method may include providing one or more recommendations to the user within the user interface, wherein the one or more recommendations are generated using a machine learning model. Accordingly, the present invention may enable improved process management by providing recommendations to a user for implementation designed to best address negative sentiment associated with particularly activities of the process.

In a further embodiment, the method may include monitoring an implementation of at least one of the one or more recommendations provided to the user into the process using at least one or more new process event logs and one or more performance metrics. Accordingly, the present invention may continue to learn and improve recommendations generated for a user such that the process management may over time become more specific to the enterprise and/or entity utilizing the process.

In yet another embodiment, the method may include presenting one or more prompts to the user within the user interface, wherein the one or more prompts are designed to gather additional feedback from the user with respect to the at least one of the one or more recommendations; and retraining the machine learning model to generate improved recommendations in the future specific to the user. Accordingly, the present invention may continue to learn and improve recommendations generated for a user such that the process management may over time become more specific to the enterprise and/or entity utilizing the process. Furthermore, the present invention may improve the capturing of a mined process as it pertains to the implementation of automation solutions by utilizing user sentiment. The current state of the art fails to describe the utilization and/or understanding of user sentiment as a success factor, the utilization of user feedback as a process criteria, and/or the current art that describes sentiment analysis does not contemplate the using the data for process mining success criteria.

In addition to a method, additional embodiments are directed to a computer system and a computer program product for leveraging collaborative sentiment to enrich processes with additional contextual data such that activities within the process may be identified for automation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a block diagram of an exemplary computing environment according to at least one embodiment; and

FIG. 2 is an operational flowchart illustrating a process for process mining and optimization according to at least one embodiment.

### DETAILED DESCRIPTION

The following described exemplary embodiments provide a system, method and program product for process mining and optimization. As such, the present embodiment has the capacity to improve the technical field of process mining and optimization by leveraging collaborative sentiment to enrich processes with additional contextual data such that activities within the process may be identified for automation. More specifically, the present invention may include identifying a process to be analyzed, wherein the process is comprised of one or more activities. The present invention my include generating a list of relevant individuals corresponding to the process and requesting access to collaborative communications between one or more individuals from the list of relevant individuals. The present invention may include generating one or more scores based on the collaborative communications between the one or more individuals. The present invention may include updating the process within the user interface using the one or more scores to enrich the process with additional contextual data.

As described previously, a process may be defined as a collection of related, structured activities or tasks performed by an entity that produce a result such as a product or service for a customer. Processes may also be utilized internally by an entity in accomplishing certain tasks. Process management may involve leveraging process mining techniques in order to adapt and/or continuously improve a process which may enable an entity to improve time to execute, delays, costs, amongst other improvements which may enable the entity to stay competitive. Process management may also include the entity identifying automation opportunities within a process by determining tasks and/or activities within the process which may be handled using a bot.

Therefore, it may be advantageous to, among other things, identifying a process to be analyzed, wherein the process is comprised of one or more activities, and wherein the process is identified based on a selection made by a user within a user interface; generating a list of relevant individuals corresponding to the process and requesting access to collaborative communications between one or more individuals from the list of relevant individuals; generating one or more scores based on the collaborative communications between the one or more individuals, wherein the one or more scores correspond to the one or more activities comprising the process; and updating the process within the user interface using the one or more scores to enrich the process with additional contextual data such that the user may visualize which of the one or more activities comprising the process provide further automation opportunities.

According to at least one embodiment, the present invention may improve the capturing of a mined process as it pertains to the implementation of automation solutions by utilizing user sentiment. The current state of the art fails to describe the utilization and/or understanding of user sentiment as a success factor, the utilization of user feedback as a process criteria, and/or the current art that describes sentiment analysis does not contemplate the using the data for process mining success criteria.

According to at least one embodiment, the present invention may improve process mining by leveraging enterprise-wide data derived from business systems to pinpoint inefficiencies and prioritize automation by impact and expected return on investment (ROI) which may enable an entity utilizing the invention to improve competitiveness, boost efficiency, and reduce operational costs.

According to at least one embodiment, the present invention may improve the time associated with executing a process, reduce delays associated with executing a process, reduce costs associated with executing a process, and improve other relevant process mining metrics by weighting a sentiment impact in conjunction with a change in process performance such that the scores associated with various activities of the processes when appended as metrics to the one or more different processes enable the user and the invention to identify automation opportunities within the one or more different processes and recommend solutions accordingly.

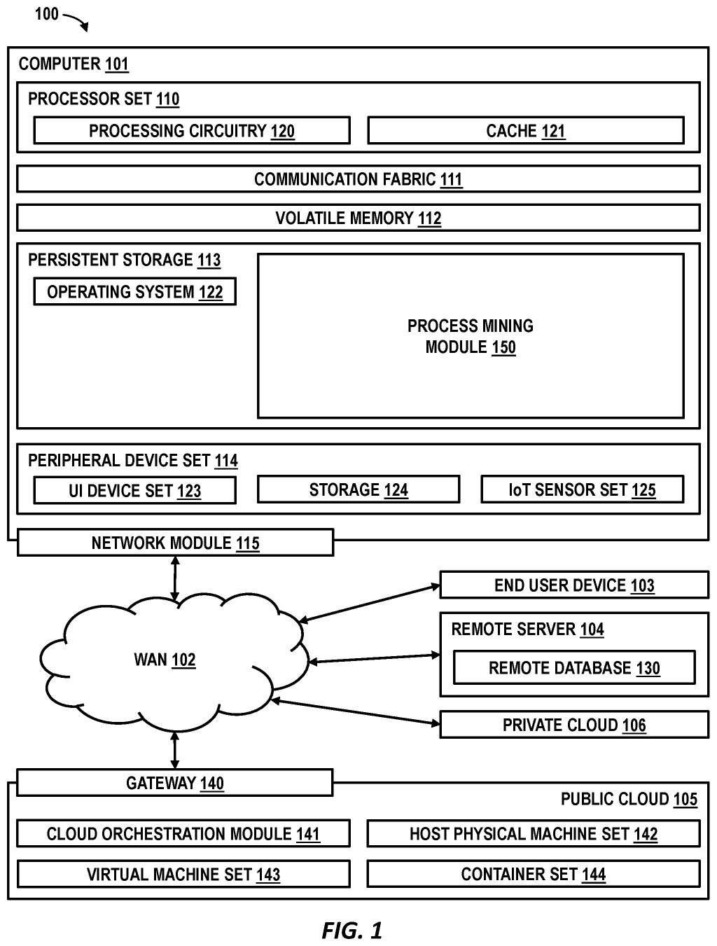

Referring to FIG. 1, Computing environment 100 contains an example of an environment for the execution of at least some of the computer code involved in performing the inventive methods, such as leveraging collaborative sentiment to enrich processes with additional contextual data such that activities within the process may be identified for automation using the process mining module 150. In addition to module 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and module 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in module 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in module 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

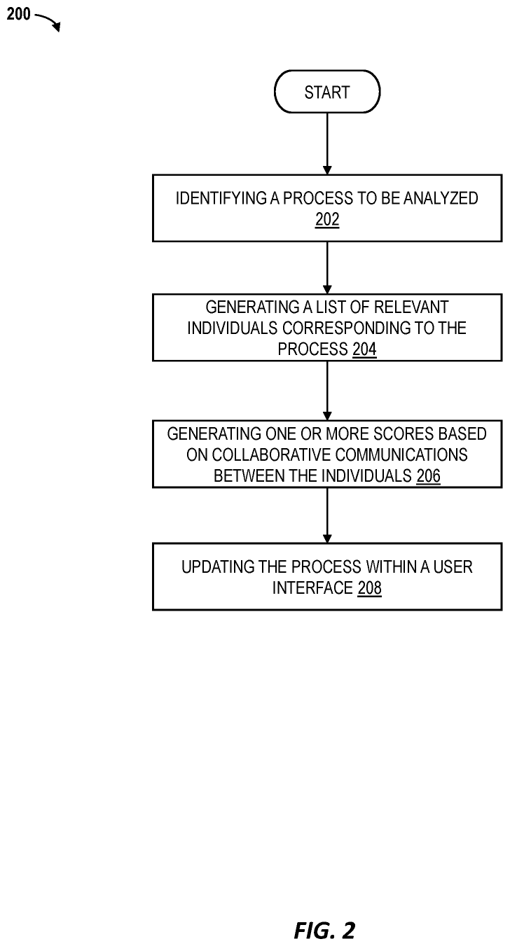

According to the present embodiment, the computer environment 100 may use the process mining module 150 to leveraging collaborative sentiment to enrich processes with additional contextual data such that activities within the process may be identified for automation. The process mining and optimization method is explained in more detail below with respect to FIG. 2.

Referring now to FIG. 2, an operational flowchart illustrating the exemplary mining and optimization process 200 used by the process mining module 150 according to at least one embodiment is depicted.

At 202, the process mining module 150 identifies a process to be analyzed. The process to be analyzed may be comprised of one or more activities. The process mining module 150 may first connect to an existing platform prior to identifying the process to be analyzed. The process mining module may connect to an existing collaborative and process mining platform in response to a user opting into the process mining module 150. The user may opt into the process mining module 150 within a user interface, wherein the process mining module 150 may display the user interface to the user as an integration with the existing collaborative and process mining platform, an internet browser, or as a dedicated software application.

The process to be analyzed may be identified based on a selection made by the user within the user interface. Although only a single process is referred to above, the process mining module 150 may be able to perform the inventive method on more than one process simultaneously according to the steps outlined below. The user may select one or more different processes conducted by the enterprise and/or entity for which the user is associated within the user interface. The enterprise and/or entity may be a company, business, manufacturer, producer, and/or other enterprise and/or entity looking to optimize one or more existing processes. The user may select the one or more different processes for which the user desires the process mining module 150 to update and fulfill with additional contextual data surrounding re-automation opportunities. There may be a plurality of options by which the user may select the one or more processes to be analyzed by the process mining module within the user interface.

For example, the use may select the process event logs corresponding to each of the one or more different processes the user wishes for the process mining module 150 to analyze. Process event logs may be a collection of time-stamped event records produced through the execution of a process, wherein each event record may include informative data related to an execution of the process and the one or more activities comprising the process. In this example, the process mining module 150 may leverage process mining solutions, such as, but not limited to, IBM® Process Mining (IBM® Process Mining and all IBM® Process Mining-based trademarks are trademarks or registered trademarks of International Business Machines Corporation in the United States, and/or other countries), to discover, create, and visualize an end-to-end process including all of the activities and various process paths associated with the one or more different processes selected by the user within the user interface based on at least the process event logs provided. In this example, the process mining module 150 may be integrated with and/or utilized as an add-on to the one or more process mining solutions, such as, IBM® Process Mining. Continuing with the example above, the process mining module 150 may also utilize one or more linguistic analysis techniques, in analyzing the process event logs corresponding to the one or more different processes selected by the user, as well as additional information provided by the user, such as individuals within the entity responsible for executing activities within the one or more different processes, an entity directory, and/or access to collaborative communication records between individuals. The additional information provided by the user and how it may be leveraged by the process mining module 150 will be described in greater detail below with respect to at least steps 204 and 206. The one or more linguistic analysis techniques may include, but are not limited to including, a machine learning model with Natural Language Processing (NLP), Latent Dirichlet Allocation (LDA), speech-to-text, Hidden markov models (HMM), N-grams, Speaker Diarization (SD), Semantic Textual Similarity (STS), Keyword Extraction, amongst other analysis techniques, such as those implemented in IBM Watson® (IBM Watson and all Watson-based trademarks are trademarks or registered trademarks of International Business Machines Corporation in the United States, and/or other countries), IBM Watson® Speech to Text, IBM Watson® Tone Analyzer, IBM Watson® Natural Language Understanding, IBM Watson® Natural Language Classifier, amongst other linguistic analysis techniques.

The one or more different processes may be a collection of related, structured activities or tasks by people and/or equipment in which a specific sequence produces a product and/or service for a customer and/or customers. The data associated with the one or more different processes may include many different aspects, such as, but not limited to, activities, ordering, duration, wait times, acting resources and/or roles, process objectives, associated values, states, milestones, decisions, Key Performance Indicators (KPIs), process outcomes, time to execute, delays, cost, amongst other relevant process mining metrics. The one or more different processes, may include, but are not limited to, processes for product production, manufacturing, loan approval, recruitment, invoicing, order processing, customer onboarding, accounting, market research, product development, amongst other processes. The data associated with the one or more different processes described above may mostly structured data, however, unstructured data such as feedback from participants and/or actors in the process may also be helpful in understanding gray areas within particular instances of the process. Unstructured data of the one or more different processes may include, but are not limited to including, comments made by an actor (e.g., a participant performing an activity within the process, person filling out a process log), text files, reports, email messages, audio files, video files, images, amongst other feedback which may be communicated through the existing collaborative and process mining platform and/or one or more parallel collaboration mediums which may be utilized by one or more individuals and/or relevant individuals of the process.

The user opting into the process mining module 150 may provide the process mining module access to at least an enterprise-wide collaboration medium and one or more process mining tools available through the existing collaborative and process mining platform. The user may also provide the process mining module access to one or more parallel collaboration mediums utilized by one or more relevant individuals within a list of relevant individuals which may identified based on currently mined process data as will be explained in more detail below at steps 204 and 206. The one or more parallel collaboration mediums may involve collaborative communications and/or other feedback from each of the one or more individuals of the list of relevant individuals surrounding the process context. The one or more parallel collaboration mediums may include mediums within the existing collaborative and process mining platform and/or other means of collaboration between individuals, such as, but not limited to, email, enterprise-wide chat platforms, cross-platform team communication tools, amongst other parallel collaboration mediums which may be utilized in relation to an implemented automation to gauge sentiment. The process mining module 150 may only access the one or more parallel collaboration mediums for which the user has expressly granted access, the user may grant access and/or revoke access to each of the one or more parallel collaboration mediums within the user interface. All collaboration data received and/or utilized by the process mining module 150 shall not be construed as to violate or encourage the violation of any local, state, federal, or international law with respect to privacy protection. In addition to the permission received by the user within the user interface the process mining module 150 may also notify and/or request access from each of the one or individuals identified within the list of relevant individuals.

At 204, the process mining module 150 generates a list of relevant individuals corresponding to the process. The process mining module 150 may generate the list of relevant individuals corresponding to each of the different processes selected by the user at step 202 and request access to collaborative communications between one or more individuals from the list of relevant individuals and/or collaborative communications relating to each of the one or more different processes and/or activities comprising those processes.

The process mining module 150 may integrate with the existing collaborative and process mining platform and retrieve a participant list based on an analysis of process event log file processing and/or the additional information provided by the user at step 202, such as individuals within the entity responsible for executing activities within the one or more different processes, an entity directory, and/or access to collaborative communication records between individuals using the one or more linguistic analysis techniques described at step 202. The process mining module 150 may use the participant list retrieved in building a list of relevant individuals, wherein the list of relevant individuals may be central to the performance and/or execution of the one or more processes identified by the user at step 202 within the user interface. The process mining module 150 may monitor the one or more process mining tools available through the existing collaborative and process mining platform to identify automated processes and/or relevant individuals involved in an upstream and/or downstream manner. The process mining module 150 may utilize current mined process data in identifying the relevant individuals. For example, the entity directory may include either the name or an associated identification number for each of a plurality of individuals employed by an entity, as well as a role within the entity. The process mining module 150 may utilize the one or more linguistic analysis techniques in matching individuals within the entity directory with the actors from the process event logs in discovering the list of relevant individuals and further being able to identify relevant communications between those individuals. The process mining module 150 may also connect to additional systems beyond those described above which may include, but are not limited to including, upstream systems, downstream systems, and/or systems that may operate in parallel such that the process mining module 150 may identify additional relevant individuals corresponding to the process according to the techniques described in greater detail above. Additionally, the process mining module 150 may also search and/or identify additional relevant individuals by modeling information disclosed by the user, such as, but not limited to, the modeling of enterprise processes from existing documentation and/or organizational charts provided by the user within the user interface and/or for which the user permitted access within the existing collaborative and process mining platform either prior to and/or after the integration of the process mining module 150. In this example, the process mining module 150 may be able to further leverage the entity directory and roles of individuals in understanding a hierarchal organizational structure of the entity such that additional relevant individuals may be identified and the collaborative communications between those individuals be requested. As will be explained in greater detail below, with respect to at least step 206, the process mining module 150 may query the list of relevant individuals requesting collaborative communications and/or other feedback from each of the individuals from the list of relevant individuals identified using the techniques described above. The process mining module 150 may utilize those communications in performing a sentiment analysis, the sentiment may be a useful tool towards understanding the effectiveness of the process, as well as bottlenecks and/or inefficiencies, and subsequently identifying hot zones. Hot zones may be points within the process that present opportunities for automation and subsequently evaluating the effectiveness of any existing Robot Process Automation (RPA) currently being utilized in the process.

As will be explained in more detail below, the process mining module 150 may identify additional activities, steps, acting resources, and/or roles within the one or more different processes which may be automated using a Robotic Process Automation (RPA) and/or other Business Process Automation tools, wherein the process mining module 150 may define a set of instructions corresponding to one or more steps of the one or more different processes to be performed using the RPA. The process mining module 150 may also leverage process mining solutions, such as, but not limited to, IBM® Process Mining (IBM® Process Mining and all IBM® Process Mining-based trademarks are trademarks or registered trademarks of International Business Machines Corporation in the United States, and/or other countries), to discover, monitor, and optimize processes using the RPA. The process mining module 150 may also leverage process mining solutions such as IBM® Process Mining in analyzing systems data received at step 202 to create and visualize an end-to-end process that includes all the process activities involved along with the various process paths for the one or more different processes selected by the user within the user interface. As will be explained in greater detail below at step 210, the process mining module 150 may additionally recommend the replacement of existing RPAs utilized within the processes and/or updated and/or generate new instructions to be provided to the RPAs to enable the RPA bot to perform additional activities and/or tasks and/or perform existing activities and/or tasks more efficiently within the one or more processes.

At 206, the process mining module 150 queries a list of the relevant individuals. The process mining module 150 may query the list of relevant individuals requesting collaborative communications and/or other feedback from each of the individuals from the list of relevant individuals identified at step 204 surrounding the process context. The collaborative communications may include at least the unstructured data described at step 202 as well as communications and/or feedback identified within the existing collaborative and process mining platform and/or the one or more parallel collaboration mediums described at step 202. The process mining module 150 may store the collaborative communications, feedback, and other unstructured data in a knowledge corpus (e.g., database 130).

The process mining module 150 may remove non-germane collaborative communications, feedback, and/or other unstructured data from the knowledge corpus (e.g., database 130) using the one or more linguistic analysis techniques described above, such as, by looking for specific keywords based on cosine similarity associated with a bot, the process, and/or an automation initiative. In at least one embodiment, the process mining module will measure the average sentiment of the process before and after a bot implementation. The specific keywords which may be utilized by the process mining module 150 may be retrieved by one or more industry domain corpus maintained by the process mining module 150 within the knowledge corpus (e.g., database 130), such as, but not limited to, an industry domain corpus for Financial Services. The process mining module 150 may also utilize one or more process domain corpus maintained by the process mining module 150 as part of the knowledge corpus (e.g., database 130) from any of the techniques which may be utilized to model and/or analyze enterprise functions and/or mappings, such as, but not limited to Component Business Models (CBM). The process mining module 150 may utilize the one or more linguistic analysis techniques described above in identifying an appropriate database to be utilized for keyword identification based on at least an analysis of the process identified by the user at step 202 and/or any additional information provided by the user.

The collaborative communications, feedback, and other unstructured data which may be identified, gathered, and stored by the process mining module 150 may be from one or more parallel collaboration mediums utilized by one or more of the relevant individuals within the list of relevant individuals. The non-germane collaborative communications may be captured based on discussions around other non-related process factors which may be manually and/or automatically trained. The non-related process factors may include, but are not limited to including, risk of automation unhappiness. For example, the collaborative communications described above may also be related to a broader enterprise effort which may be managed through one or more collaborative transformation management approaches which may leverage collaborative boards utilized by the relevant individuals to communicate notes, track progress of work items, and monitor stages of the process. In this example the process mining module 150 may leverage collaborative communications, feedback, unstructured data, as well as progress indicators within the collaborative boards in further understanding the process sentiment.

At 208, the process mining module 150 generates one or more scores based on the collaborative communications between the one or more individuals. The one or more scores may include a score assigned to the process overall and/or one or more scores which may correspond to the one or more activities comprising the process. The score assigned to the process overall may the average of the one or more scored corresponding to the one or more activities comprising the process. The process mining module 150 generates a score based on the sentiment derived from the collaborative communications of the list of relevant individuals for each of the one or more processes and/or activities within the processes identified by the user within the user interface. The score generated by the process mining module 150 may be a numerical value, wherein the numerical value generated may correspond to a sentiment of the list or relevant individuals for each of the one or more processes. In at least one embodiment, the numerical value may range from negative 1 to positive 1 and correspond to the level of negative sentiment and/or positive sentiment for each of the one or more processes and/or the sentiment of the one or more activities comprising each of the one or more processes.

The score generated by the process mining module 150 may be an aggregate sentiment score which may be captured and processed based on relevant individual collaborative communications surrounding the process. The process mining module 150 may weight the sentiment impact in conjunction with a change in process performance which may be measured using at least the data associated with the one or more different processes described in detail at step 202, such as, for example, time to execute, delays, cost, amongst other relevant process mining metrics. As will be explained in more detail below, these mining module outputs may be utilized to better understand the underlying process and determine candidates for additional analysis and/or investigation and/or utilized to provide a ranking of process changes according to prioritization determined at least in part based on the sentiment of the relevant individuals for the process changes. The ranking of activities and/or process changes may be at least partially based on a corresponding sentiment score, such that the ranking of the activities and/or process changes associated with those activities within the process are designed to provide the greatest level of improvement to the process as according to one or more performance metrics and/or improvement to the sentiment of the relevant individuals corresponding to the process.

At 210, the process mining module 150 updates the process within the user interface. The process mining module 150 may update each of the one or more processes identified by the user at step 202 using the one or more scores determined at step 208 to enrich the process with additional contextual data. The enriched process may enable the user to visualize through the user interface which of the one or more processes and/or which of the one or more activities comprising the one or more processes provides further automation opportunities. The updated processes may correspond to updates within the existing collaborative and process mining platform by at least fulfilling and/or updating the one or more with additional contextual data surrounding re-automation opportunities.

The process mining module 150 may utilize a machine learning model in identifying activities within the process that provide further automation opportunities based on at least the ranking of the activities and/or process changes associated with those activities derived from the one or more scores generated based on the sentiment derived from the collaborative communications between the one or more individuals corresponding to the activities within the processes identified by the user at step 202. In at least one embodiment, the process mining module 150 may utilize a functional business model of the enterprise, such as, but not limited to a CBM and support the understanding of the process utilizing the machine learning model which may be implemented using Generative Artificial Intelligence (Generative AI) to integrate with the CBM. The machine learning model may leverage the ranking of the activities and/or process changes in performing AI powered process simulations. The AI powered process simulations utilized by the process mining module 150 may leverage one or more simulation methods, the one or more simulation methods may include, but are not limited to including, a Monte Carlo simulation process, agent based simulation model, discrete event simulation model, and/or a system dynamic simulation model, amongst other simulation methods. The process mining module 150 may additionally utilize a statistical program such as IBM's SPSS® (SPSS® and all SPSS-based trademarks are trademarks or registered trademarks of International Business Machines Corporation in the United States, and/or other countries), or Statistical Product and Service Solution, in optimizing the one or more simulation methods. As will be explained in more detail below, the process mining module 150 may provide one or more recommendations to the user using the output of the machine learning model, wherein the machine learning model utilizes the ranking of the activities and/or process changes, the CBM, sentiment scores, amongst other input derived from steps 202 through 208 to simulate various adjustments to the process, including automation implementations, and provides one or more recommendations to the user within the user interface accordingly. In this embodiment, the process mining module 150 may present metric improvements derived from the simulations to the user within the user interface such that the user may select which of the one or more recommendations to implement based on, for example, KPI comparisons.

The one or more recommendations may be presented to the user within the user interface as an integration with a graphical display of the enriched process with the added contextual data. The graphical display may be interactive and enable the user to perform various click actions to interact with and visualize the enriched process such that the user may be able to click on bottlenecks, inefficiencies, and/or hot zones identified within the process by the process mining module 150 and select recommendations to address those bottlenecks, inefficiencies, or hot zones. Additionally, prior to submitting a selected recommendation the process mining module 150 may utilize the machine learning model described above to simulate the selected recommendation and display the simulation, the updated process following the implemented recommendation, as well as the projected metric improvements. As will be explained in more detail below, the machine learning model may learn more about the user, relevant individuals, processes, and/or entity and/or enterprise associated with the processes and relevant individuals over time such that the process mining module 150 may provide user specific recommendations as the process and collaborative communications are further monitored and feedback received. All of which may be stored in the knowledge corpus (e.g., database 130) which may be further comprised of enterprise and/or process knowledge corpus (e.g., personal database) which may be utilized in further training and/or retraining the machine learning model according to the preferences of the enterprise and/or according to the specific individuals associated with each process identified by the user at step 202.

The process mining module 150 may monitor the implementation of the recommendations by the user using at least new process event logs associated with the one or more processes, additional communications between relevant individuals, feedback, additional unstructured data, new data associated with one or more updated processes, such as, but not limited to, time to execute, delays, cost, effectiveness of RPA, KPIs, amongst other process mining metrics and/or performance metrics following an implementation of the one or more recommendations. The process mining module 150 may also update the one or more scores generated at step 208 during the monitoring process. The process mining module 150 may update the one or more scores after the implementation of each recommendation and/or change to the process such that the updates scores may be stored with the original scores in the enterprise and/or process knowledge corpus (e.g., personal database) such that they may be retrieved and displayed to the user within the user interface to communicate improvement progress with respect to each process to the user in the user interface. The process mining module 150 may also iteratively update the one or more scores at a time interval determined by the user within the user interface. The process mining module 150 may be prompted by deviations in those scores, in either direction, to generate one or more prompts and/or notifications within the user interface which may be designed to gather additional details and/or feedback from the user, which will be described in greater detail below. The process mining module 150 may also directly communicate with relevant individuals using the one or more parallel collaboration mediums described above in order to gather additional data and/or feedback. For example, the list of relevant individuals corresponding to the process generated at step 204 may include an individual tasked with performing a specific task and/or completing a specific activity within the process. In monitoring the process, the process mining module 150 may identify bottlenecks within the process occurring as a direct result of the specific activity within the process associated with the relevant individual. In this example, the process mining module 150 may utilize an integrated chatbot to message the relevant individual to gather additional details or feedback related to the activity.

As part of monitoring the implementation of the one or more recommendations, the process mining module 150 may also request additional details and/or feedback from the user following the implementation of the recommendations and/or automation processes such that the process mining module 150 may understand the costs, time, and drawbacks associated with the implementation of the one or more recommendations. This feedback may be stored in at least the knowledge corpus (e.g., database 130) and/or the enterprise and/or process knowledge corpus (e.g., personal database) and utilized in retraining the machine learning model to additionally factor in implementation drawbacks associated with recommendations such that those considerations may be weighed accordingly in the future. The feedback received from the user may be analyzed using the sentiment analysis tools and/or linguistic analysis techniques described above at steps 204-208. The monitoring of the recommendations and/or feedback may be further utilized by the process mining module 150 in improving the RPA by identifying the tasks or activities for which the RPA may be improved or updating the instructions provided to the RPA bot such that the set of instructions provided to the RPA bot improves the process performance metrics and/or enables the RPA bot to perform additional tasks and/or activities within the process which may suffer from inefficiencies or bottlenecks. The process mining module 150 may continuously update the instructions provided to the RPA bot as additional opportunities for automation within the process are identified, wherein the updated instructions enable the RPA bot to perform one or more activities within the process which were previously not automated. The process mining module 150 may continuously monitor the process and request additional details and/or feedback such that the machine learning model may continuously improve future recommendations and identify additional automation opportunities. The machine learning model may be retrained based on continuous updating of the enterprise and/or process knowledge corpus (e.g., personal database) such that future recommendations are more specific to user requirements and resources for both the processes identified by the user at step 202 and/or additional processes identified by other user associated with the entity or enterprise. The machine learning model may also be retrained more generally such that recommendations may be improved, projected process performance metrics are more accurate, and additional automation opportunities are identified for other users of the process mining module 150 within other entities or enterprises.

The additional contextual data surrounding re-automation opportunities may include, but is not limited to including, utilizing the score generated based on the collaborative communications as additional metrics which may be appended to the one or more different processes within the existing collaborative and process mining platform. The process mining module 150 may stratify and identify opportunities within the user interface for each of the one or more different processes in which the score and/or general sentiment may be improved. In at least one embodiment, the process mining module 150 may identify opportunities within the user interface by using the weighting of the sentiment impact in conjunction with the change in process performance in generating a process mined rank of further automation candidates. In at least one embodiment, the process mining module 150 may utilize a positive sentiment score towards a particular process element for ranking the user case higher within a project management framework, such as an Agile list, for automation execution.

The process mining module 150 may update the existing collaborative and process mining platform by at least fulfilling and/or updating the one or more different processes selected by the user at step 202 with additional contextual data surrounding re-automation opportunities. The process mining module 150 may further utilize the additional contextual data in generating an enriched process for each of the one or more different processes identified by the user within the user interface at step 202. The enriched process may include all of the data associated with the one or more different processes, such as, but not limited to, activities, ordering, duration, wait times, acting resources and/or roles, process objectives, associated values, states, milestones, decisions, Key Performance Indicators (KPIs), process outcomes, time to execute, delays, cost, amongst other relevant process mining metrics, as well as the scores generated by the process mining module 150 based on the collaborative communications, feedback, and/or other unstructured data, and other additional metrics which may be appended to the one or more different processes in generating the one or more enriched processes. The enriched processes may include visual representations, such as unique colors, numbers, or flags, which enable the user to clearly identify areas of the enriched business process which may be improved. The process mining module 150 may utilize at least the visual representations above to pinpoint inefficiencies and rank the automation candidates to prioritize impact on each of the one or more processes to optimize an ROI of the user which may enable the process mining module to improve competitiveness, boost efficiency, and reduce operational costs.

It may be appreciated that FIG. 2 provides only an illustration of one embodiment and do not imply any limitations with regard to how different embodiments may be implemented. Many modifications to the depicted embodiment(s) may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of one or more transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for process mining and optimization, the method comprising:
identifying a process to be analyzed, wherein the process is comprised of one or more activities, and wherein the process is identified based on a selection made by a user within a user interface;
generating a list of relevant individuals corresponding to the process and requesting access to collaborative communications between one or more individuals from the list of relevant individuals;
generating one or more scores based on the collaborative communications between the one or more individuals, wherein the one or more scores correspond to the one or more activities comprising the process; and
updating the process within the user interface using the one or more scores to enrich the process with additional contextual data.

2. The method of claim 1, wherein the additional contextual data enables the user to visualize, within the user interface, which of the one or more activities comprising the process provides further automation opportunities.

3. The method of claim 1, wherein the one or more scores are a numerical value corresponding to a sentiment derived from the collaborative communications between the one or more individuals.

4. The method of claim 1, further comprising:
providing one or more recommendations to the user within the user interface, wherein the one or more recommendations are generated using a machine learning model.

5. The method of claim 4, wherein the machine learning model utilizes one or more simulation methods to identify the one or more recommendations which will improve a sentiment associated with the one or more scores generated based on the collaborative communications.

6. The method of claim 4, further comprising:
monitoring an implementation of at least one of the one or more recommendations provided to the user into the process using at least one or more new process event logs and one or more performance metrics;
presenting one or more prompts to the user within the user interface, wherein the one or more prompts are designed to gather feedback from the user with respect to the at the at least one of the one or more recommendations; and
retraining the machine learning model to generate improved recommendations in the future specific to the user.

7. The method of claim 6, wherein the improved recommendations includes updating instructions provided to a Robotic Process Automation (RPA) bot, wherein the instructions enable the RPA bot to perform one or more activities of the process which were previously not automated.

8. A computer system for process mining and optimization, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
program instructions, stored on at least one of the one or more computer-readable storage media for execution by at least one of the one or more processors via at least one of the one or more memories, to identify a process to be analyzed, wherein the process is comprised of one or more activities, and wherein the process is identified based on a selection made by a user within a user interface;
program instructions, stored on at least one of the one or more computer-readable storage media for execution by at least one of the one or more processors via at least one of the one or more memories, to generate a list of relevant individuals corresponding to the process and requesting access to collaborative communications between one or more individuals from the list of relevant individuals;
program instructions, stored on at least one of the one or more computer-readable storage media for execution by at least one of the one or more processors via at least one of the one or more memories, to generate one or more scores based on the collaborative communications between the one or more individuals, wherein the one or more scores correspond to the one or more activities comprising the process; and
program instructions, stored on at least one of the one or more computer-readable storage media for execution by at least one of the one or more processors via at least one of the one or more memories, to update the process within the user interface using the one or more scores to enrich the process with additional contextual data.

9. The computer system of claim 8, wherein the additional contextual data enables the user to visualize, within the user interface, which of the one or more activities comprising the process provides further automation opportunities.

10. The computer system of claim 8, wherein the one or more scores are a numerical value corresponding to a sentiment derived from the collaborative communications between the one or more individuals.

11. The computer system of claim 8, further comprising:
program instructions, stored on at least one of the one or more computer-readable storage media for execution by at least one of the one or more processors via at least one of the one or more memories, to provide one or more recommendations to the user within the user interface, wherein the one or more recommendations are generated using a machine learning model.

12. The computer system of claim 11, wherein the machine learning model utilizes one or more simulation methods to identify the one or more recommendations which will improve a sentiment associated with the one or more scores generated based on the collaborative communications.

13. The computer system of claim 11, further comprising:
program instructions, stored on at least one of the one or more computer-readable storage media for execution by at least one of the one or more processors via at least one of the one or more memories, to monitor an implementation of at least one of the one or more recommendations provided to the user into the process using at least one or more new process event logs and one or more performance metrics;
program instructions, stored on at least one of the one or more computer-readable storage media for execution by at least one of the one or more processors via at least one of the one or more memories, to present one or more prompts to the user within the user interface, wherein the one or more prompts are designed to gather feedback from the user with respect to the at the at least one of the one or more recommendations; and
program instructions, stored on at least one of the one or more computer-readable storage media for execution by at least one of the one or more processors via at least one of the one or more memories, to retrain the machine learning model to generate improved recommendations in the future specific to the user.

14. The computer system of claim 13, wherein the improved recommendations includes updating instructions provided to a Robotic Process Automation (RPA) bot, wherein the instructions enable the RPA bot to perform one or more activities of the process which were previously not automated.

15. A computer program product for process mining and optimization, comprising:
one or more computer readable storage media, and program instructions collectively stored on the one or more computer readable storage media, the program instructions comprising:
program instructions, stored on at least one of the one or more computer-readable storage media, to identify a process to be analyzed, wherein the process is comprised of one or more activities, and wherein the process is identified based on a selection made by a user within a user interface;
program instructions, stored on at least one of the one or more computer-readable storage media, to generate a list of relevant individuals corresponding to the process and requesting access to collaborative communications between one or more individuals from the list of relevant individuals;
program instructions, stored on at least one of the one or more computer-readable storage media, to generate one or more scores based on the collaborative communications between the one or more individuals, wherein the one or more scores correspond to the one or more activities comprising the process; and
program instructions, stored on at least one of the one or more computer-readable storage media, to update the process within the user interface using the one or more scores to enrich the process with additional contextual data.

16. The computer program product of claim 15, wherein the additional contextual data enables the user to visualize, within the user interface, which of the one or more activities comprising the process provides further automation opportunities.

17. The computer program product of claim 15, wherein the one or more scores are a numerical value corresponding to a sentiment derived from the collaborative communications between the one or more individuals.

18. The computer program product of claim 15, further comprising:
program instructions, stored on at least one of the one or more computer-readable storage media, to provide one or more recommendations to the user within the user interface, wherein the one or more recommendations are generated using a machine learning model.

19. The computer program product of claim 18, wherein the machine learning model utilizes one or more simulation methods to identify the one or more recommendations which will improve a sentiment associated with the one or more scores generated based on the collaborative communications.

20. The computer program product of claim 18, further comprising:
program instructions, stored on at least one of the one or more computer-readable storage media, to monitor an implementation of at least one of the one or more recommendations provided to the user into the process using at least one or more new process event logs and one or more performance metrics;
program instructions, stored on at least one of the one or more computer-readable storage media, to present one or more prompts to the user within the user interface, wherein the one or more prompts are designed to gather feedback from the user with respect to the at the at least one of the one or more recommendations; and
program instructions, stored on at least one of the one or more computer-readable storage media, to retrain the machine learning model to generate improved recommendations in the future specific to the user.
